(19) United States
(12) Patent Application Publication
(10) Pub. No.: US 2026/0332608 A1
(43) Pub. Date: Oct. 22, 2026

(54) METADATA ANALYSIS TO DETECT MALICIOUS CONTENT UPLOAD AND ACCESS

(71) Applicant: Dell Products L.P., Round Rock, TX (US)

(72) Inventors: Ahmed Khalid, Cork (IE); Alan Barnett, Co. Cork (IE); Judith A. Furlong, Natick, MA (US)

(21) Appl. No.: 19/184,631

(22) Filed: Apr. 21, 2025

(51) Int. Cl. H04L 9/40; G06F 16/23

(52) U.S. Cl. CPC H04L 63/1416; G06F 16/2379; H04L 63/1441

(57) ABSTRACT

Securing network nodes of a distributed ledger by detecting undesirable content is disclosed. When a transaction is received from a client, metadata of the transaction and/or the content of the transaction is analyzed for undesirable content by each of the nodes. The nodes may perform the same content analysis or customized content analysis. The metadata content analysis may identify undesired in content in nodes based on characteristics of the transaction. The nodes, after performing the metadata content analysis, vote on whether to accept the transaction. When consensus is achieved among the nodes, the transaction is committed to the distributed ledger.

### TECHNOLOGICAL FIELD OF THE DISCLOSURE

Embodiments disclosed herein generally relate to distributed ledger technologies. More particularly, at least some embodiments relate to systems, hardware, software, computer-readable media, and methods for committing transactions to a distributed ledger and more particularly to metadata-based detection of undesirable content in transactions of the distributed ledger.

### BACKGROUND

Distributed ledger technologies (DLTs) (e.g., blockchains) are decentralized systems that enable transactions to be recorded across multiple nodes within a distributed ledger network. The ability to immutably store transactions is a significant benefit of DLTs. When committing a transaction to a distributed ledger network, cryptographic techniques are used to create an immutable and chronological chain of transactions (e.g., blocks or graphs). The chain of transactions, and the content within the transactions, is stored on all the nodes in the DLT network. This configuration ensures that no single entity has complete control of the transactions or has the ability to tamper with the transactions. The distributed and tamper-resistant nature of DLTs enhances transparency, reduces the risk of fraud, and facilitates trust among participants in the distributed ledger network. These characteristics make DLTs suitable for applications such as cryptocurrencies, smart contracts, and supply chain management.

These characteristics can also complicate the ability to resolve security and compliance concerns. For example, much effort has been given to identify security and compliance concerns related to hosting public immutable data in an organization’s network and to devise solutions that can mitigate threats and non-compliance.

For example, security/compliance issues facing organizations that host public immutable data include issues related to undesirable content, such as illegal content. Freely editable fields, for example, are exploited to place illegal content in a DLT. The illegal content often includes the kind of imagery that is illegal in virtually every country but could also include content such as leaked personal identifying information.

Storing or distributing illegal content is a significant problem for DLT services and participants. Nonetheless, prominent DLTs presently have instances of such imagery or other illegal content. There is low impetus for removing illegal content even amongst platforms where removal is relatively trivial, such as in social media. Removing illegal content from a DLT typically requires enormous effort due to the immutable nature of the DLT. For example, carrying out a hard fork may resolve the issue, but involves substantial effort.

Other than the effort of removal, the presence of illegal content on a DLT does not functionally impact the day-to-day running of the DLT and until recently, there has not been significant pressure, or consequences imposed by authorities to motivate these platforms to combat the issue.

The implications of illegal content do not stop at the platform or service provider level. When illegal content is placed on a node of a DLT, the illegal content will propagate to other nodes in the DLT, which are under an obligation to run in compliance with the up-to-date network version. The person or entity running the DLT node, as a consequence, is technically in possession of illegal content.

Undesirable content may also pose a potential security vulnerability. For instance, injecting content into the DLT could be used for backdoor patching viruses already deployed or may be leveraged as part of an injection attacked.

Recently, various jurisdictions and collective are placing increased responsibility on DLT platforms and services to combat illegal content on their systems. Examples include the European Union’s Digital Services Act and the United Kingdom’s Online Safety Bill. While social media and file shares are a primary focus of this legislation, DLTs are in an untenable position and need to address these concerns to preserve functionality and maintain compliance.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:
FIG. 1A discloses aspects of a distributed ledger;
FIG. 1B discloses aspects of a transaction in a distributed ledger;
FIG. 2 discloses aspects of committing a transaction to a distributed ledger;
FIG. 3 discloses aspects of detecting undesirable content and preventing undesirable content from being stored in a distributed ledger;
FIG. 4 discloses additional aspects of committing a transaction by nodes that rejected the transaction during execution of a consensus mechanism; and
FIG. 5 discloses aspects of a computing device, system, or entity.

### DETAILED DESCRIPTION OF SOME EXAMPLE EMBODIMENTS

Embodiments disclosed herein generally relate to distributed ledger technologies (DLTs). More particularly, at least some embodiments relate to systems, hardware, software, computer-readable media, and methods for preventing undesirable content from being committed to distributed ledgers. Embodiments of the invention further relate to metadata-based detection of undesirable content, which undesirable content may be obscured or hidden (e.g., encrypted, encoded).

Embodiments of the invention relate to DLTs, such as blockchains, where autonomous decentralized nodes work together to create replicas of an immutable ledger. Embodiments of the invention may be implemented in various DLT platforms or services and can be adapted to the details (e.g., protocols, architectures) of specific DLTs. Hedera, Bitcoin, Ethereum, and Hyperledger are examples of DLTs in which embodiments of the invention may be implemented. DLTs and the like are referred to herein as distributed ledgers by way of example. In one example, each node participating in a distributed ledger maintains a copy or replica of the distributed ledger. Transactions received into the distributed ledger are replicated or added to each of the replicas in the distributed ledger.

Embodiments of the invention are discussed in the context of a distributed ledger and transactions that are stored or committed to the distributed ledger. Distributed ledgers may be public, private, permissioned, permissionless, or the like. A distributed ledger may include nodes (e.g., servers, clusters with processors and memory) and the nodes may be implemented in the cloud, at the edge, on-premise, or the like or combinations thereof.

By way of example and not limitation, a distributed ledger may be associated with transactions and messages. A transaction may relate to changes in the ledger. Example transactions may relate to digital assets, digital currency, asset transfer, recording data, smart contracts, or the like or combinations thereof. Generally, valid transactions are committed to the distributed ledger. Messages, in contrast, may be used to convey information and messages may or may not be committed to the distributed ledger. For example, messages may be used for status updates, commands, voting, protocols, node communications, or the like or combinations thereof. Embodiments of the invention focus on transactions that are changes to the distributed ledger and are immutably stored therein. More generally, embodiments of the invention relate to data that is committed to a distributed ledger and may be applied to various DLTs, which may use different protocols and communication methods. However, messages, which may or may not be committed to the distributed ledger may be subject to content analysis operations as disclosed herein.

In some examples, each node of a distributed ledger may be configured to conduct content analysis operations to identify undesirable content. In one example, the content analysis operations may be the same at each of the nodes.

In another example, different nodes may have different perceptions of what qualifies as undesirable content. Designating content as undesirable content may be influenced by location, local regulations, and the like. Thus, content that is acceptable from the perspective of one node may be undesirable from the perspective of another node. Embodiments of the invention provides nodes with flexibility to make their own determinations based on their specific circumstances and requirements and provide various methods for committing a transaction deemed acceptable by the nodes of the distributed ledger.

In both instances, the content analysis operations may include metadata-based content analysis functions are operations that are configured to detect undesirable content based on metadata rather than the content itself. This allows, by way of example, undesirable content to be detected even if the undesirable content is encrypted, encoded, or the like.

Embodiments of the invention may provide or include application programming interfaces (APIs) that can be used by the nodes when detecting undesirable content in a transaction. Content of a transaction (or the transaction itself) can be passed to analyzers (e.g., content analyzers, compliance analyzers or other functions) using these APIs.

Nodes of a distributed ledger are often required to commit approved transactions to their respective copies of the distributed ledger. When nodes (or node operator) run their own content (and/or compliance) analysis operations, a scenario may arise where nodes of the distributed network reach consensus to commit a particular transaction to the distributed ledger even though some nodes vote to reject the transaction. In these scenarios, the nodes that flag the transaction (e.g., because the content is deemed undesirable by the node) will be required to store the transaction in their copies of the distributed ledger in order to maintain compliance with the consensus protocol and the distributed ledger network.

In some embodiments, this issue is addressed by adding a header (e.g., a header field, metadata) to the transaction or block (i.e., the immutable unit in the distributed ledger) to track the votes of the nodes in the distributed ledger. Conventionally, the voting process and results are not tracked by consensus mechanisms. Adding a header for storing aspects and/or results of the consensus mechanism (e.g., the voting process) ensures that results of the vote are stored directly in the copies of the distributed ledger and can help organizations in fulfilling compliance assessments or audits mandated by regulatory authorities. Furthermore, tracking the votes enables nodes that object to the transaction to generate and write hashes (or other representations) of the transaction to their copies of the distributed ledger, while maintaining pointers to nodes that persisted the transaction to the distributed ledger. Stated differently, the headers may be used to find a node that stores the transaction rather than a hash of the transaction. Embodiments of the invention may be implemented with various voting operations performed by a consensus mechanism such as, but not limited to, Delegated Proof of Stake, Byzantine Fault Tolerance (BFT) algorithms, Hashgraph.

Embodiments of the invention allow nodes to detect, report, reject, or save transactions from clients to their respective copies of the distributed ledger, irrespective of the decisions made by other nodes in the distributed ledger.

FIG. 1A discloses aspects of an example distributed ledger. A distributed ledger 100 includes nodes, represented as nodes 102, 104, 106, and 108. The nodes 102, 104, 106, and 108 may be associated with different operators, in different geographical locations, connected to different networks, and the like. The distributed ledger 100 is implemented by creating a replica or copy of the ledger at each of the nodes. Thus, the distributed ledger 100 is represented by copies of the ledger stored at or accessible by the nodes 102, 104, 106, and 108. The nodes 102, 104, 106, and 108 are able to communicate with one another.

In this example of the distributed ledger 100, the node 102 stores and runs a copy or replica of the ledger, illustrated as the ledger 102a. The copies or replicas of the distributed ledger stored by the nodes 104, 106, and 108 are represented as, respectively, ledgers 104a, 106a, and 108a. The ledgers 102a, 104a, 106a, and 108a may be implemented in non-transitory memory or storage devices.

In this example of the distributed ledger 100, the network nodes 102, 104, 106, and 108 store the transactions that are received by the distributed ledger 100 to their respective internal storage – the ledgers 102a, 104a, 106a, and 108a. This may lead to potential legal or technical challenges if content in the transactions is or includes undesirable content (e.g., malicious content, illegal content, non-compliant content). In some examples, the manner in which a transaction is committed to the distributed ledger may depend on whether the content of the transaction is viewed as undesirable.

In one example, network nodes 102, 104, 106, and 108 receive transactions from clients. For example, the distributed network 100 may be used to store digital wallets, each associated with a different client. A client may desire to transfer an asset to another client or elsewhere and this is achieved by sending a transaction to the distributed ledger 100.

The nodes 102, 104, 106, and 108 validate transactions and execute a consensus mechanism for each of the transactions. Once consensus is reached among the nodes 102, 104, 106, and 108 with respect to a particular transaction, each node adds that particular transaction and the associated content to its corresponding replica or copy of the distributed ledger using cryptographic techniques in one example. Thus, the node 102 adds the validated transaction to the ledger 102a, the node 104 adds the validated transaction to the ledger 104a, the node 106 adds the validated transaction to the ledger 106a, and the node 108 adds the validated transaction to the node 108a. This creates replicas of an immutable transaction log across all the network nodes 102, 104, 106, and 108.

In this example, transactions, but not messages, are committed to the distributed ledger. In other examples, transactions and messages are committed to the distributed ledger. More generally, different DLTs may have different protocols and terminology. This example assumes that at least transactions are committed to the distributed ledger 100.

Further, a transaction may be received at one node (e.g., the node 102) or at multiple nodes (e.g., at the nodes 102 and 104). The distributed ledger 100 may have a mechanism or protocol to forward or share the transaction with the other nodes in the distributed ledger 100. This ensures that the ledgers 102a, 104a, 106a, and 108a are kept up to date and consistent over time as transactions are validated and reviewed for undesirable content.

In one example, during the consensus mechanism, the node 102 may vote to reject the transaction while the other nodes 104, 106, and 108 vote to accept the transaction. Although consensus is achieved (e.g., majority of nodes voted to accept the transaction), the manner in which the transaction is committed to the distributed ledger may vary at each node.

In one example, the transaction is simply committed to each replica of the distributed ledger.

In another example, the nodes 104, 106, and 108 may add a header to the transaction and commit both the header and the transaction to, respectively, the ledgers 104a, 106a, and 108a. The header may identify all nodes that voted to accept the transaction or identify all nodes and their vote.

The node 102 also generates the same header in one example. However, the node 102 may store a hash of the content (or of the transaction) in the ledger 102a. Proofs are also stored or available with regard to the hash. This allows the node 102 to store the transaction without actually storing the undesirable content. If the node 102 receives a request for this transaction, the request may be directed to other nodes, using the nodes that voted to accept the content in the header. In one example, the values placed in the headers can be verified, enforced, audited, secured, and the like such that the headers are legitimate representations of the nodes that voted and the content of their vote. The voting mechanism may provide the ability to legitimately add this type of header. The validity of the hash can be verified using the content stored on other nodes of the distributed ledger.

FIG. 1B discloses aspects of a transaction in a distributed ledger. Although transaction in a distributed ledger are often stand-alone transactions, some transactions may be related. Thus, the transactions 150 and 170 can be considered to be stand-alone transactions. Alternatively, FIG. 1B can be viewed as a series 176 of related transactions that is represented by transactions 150 and 170.

Generally, transactions of a distributed ledger include fields or follow a certain format. By way of example and not limitation, the fields 148 of the transaction 150 include a signature 152, a sender 154, a recipient 156, a transaction identifier 158, a transaction type 160, an amount 162, an optional field 164, and a timestamp 166. The specific format and collection of fields for a particular DLT may vary and may be defined by the DLT.

In this example, the fields 172 are the same as the fields 148, although the content of the specific fields may vary from one transaction to the next. For example, transaction identifiers, timestamps, and the like may have a specified format, but are different in terms of value.

In this example, the fields 148 and 172 include, respectively, optional fields 164 and 174. The optional fields 164 and 170 may be free-text fields and provide clients with flexibility in terms of including content or data with a transaction. Headers may also be examples of optional fields 164.

In some examples, a client may add or insert undesirable content in the optional fields 164 and 174. Undesirable content may be placed in a single transaction or in one or more transactions of a series of transactions. Transactions may be related or linked as a series by sender, recipient, or the like. A client may also insert undesirable content into the other fields. For example, undesirable content may be added to any unused space in any of the fields.

Embodiments of the invention further relate to detecting undesirable content based on characteristics (metadata) of the transactions being uploaded (e.g., added) to the distributed ledger. In one example, undesirable content may be detected in the fields 148, including the optional fields 164 and 174 based on metadata.

Although FIG. 1B illustrates transactions 150 and 170, embodiments of the invention may also apply to messages, which may have a similar format or architecture. For example, the transaction 150 may have a transaction length, the fields 148 may have a predetermined size as a whole, each of the fields may have predefined lengths, and the like. Undesirable content may be added to messages, transactions, and/or their fields. A typical target for inserting undesirable content is the optional field 164 (or text or memo field).

Metadata can be extracted or derived from these fields 148 and/or the manner in which these fields 148 are employed. This metadata (or their features) may be input in artificial intelligence or machine learning models to identify patterns and the like. Models may learn to identify undesirable content. Models, for example, can be constructed or trained to recognize patterns that reflect “normal” uploads or normal transactions and flag anomalous transactions as suspicious. More specifically, historical data representing undesirable content (and/or normal content) can be used to train a model to recognize suspicious transactions. In another example, models trained with normal or acceptable content may identify undesirable content as an outlier.

Embodiments of the invention operate on metadata related to, in one example, the metadata surrounding the transaction itself, the process surrounding the upload of the transaction, and the like. The content of the data may not be analyzed by the metadata analyzer, at least because the content may be encrypted or encoded. However, the fact that data is encrypted may be considered as an indication of undesirable content in some examples.

Embodiments of the invention relate, more specifically, to problems associated with encoding, encryption, or other methods to render undesirable content unreadable before placing the content in a distributed ledger. Because the content is encoded, encrypted, or the like, conventional content analysis may not identify these transactions or their as undesirable. Embodiments of the invention thus relate to detecting undesirable content based on metadata of or derived from the content itself, characteristics of the process in which the undesirable content was uploaded, and the like. Thus, encrypted or encoded content can be identified as undesirable and rejected based on metadata based content analysis alone by a distributed ledger.

As previously stated, a transaction may have a predetermined size and fields of the transaction may also predetermined sized. As a result, the act of placing undesirable content in a distributed ledger may require the client placing the undesirable content to conform the data to these size constraints. For example, if a header (or optional field or other field) only allows 256 bits, the client is either limited to 256 bits or is required to distributed the undesirable content across multiple transactions (e.g., the series 176) of transactions. Further, the client may be required to share the locations of the transactions with their customers or recipients.

In this example, the header may be completely full, which may not be typical of a normal transaction and may be a pattern that can be recognized. Examining the manner in which this transaction was uploaded may determine that multiple transactions were uploaded, by the same client, withing a short time window.

These characteristics can be analyzed, for example by pattern recognition, to identify the presence of undesirable content without having to analyze the content itself. More specifically, metadata may include the number of transactions, full use of the header field (e.g., the optional field 164), full use of the header field across multiple transactions, the identity of the sender or Internet Protocol address of the sender for the transactions, the time frame of the transactions, a batch nature of the transactions, or the like or combinations thereof.

In addition to detecting undesirable transaction based on metadata associated with uploading a transaction or set of transactions, embodiments of the invention may also monitor aspects of accessing transactions. For example, a particular transaction or series of transaction may be accessed by multiple users over a short time frame, from a particular location, by non-recipients of the original transactions, or the like. In addition to preventing undesirable content or transactions from being committed to the distributed ledger based on upload patterns (metadata), embodiments of the invention may monitor the distributed ledger in order to identify undesirable content based on access patterns (metadata).

Embodiments of the invention, in addition to using existing metadata, may also enrich the metadata with artificial intelligence and machine learning models that may be trained to detect patterns from the perspective of one or more transactions. For example a model may detect patterns in user behavior in the uploading and/or accessing of transactions, which may be indicative of undesirable content. This may also allow the characteristics of the undesirable content to be identified and reported, such as client, location, and the like. For example, ratios of used space to unused space on a transaction basis and/or field based may be examples of metadata that may be extracted. The understandability of content (e.g., not encrypted or encoded). Features or metadata such as related transaction (and number of transactions) within a time window may be determined and used to conduct metadata-based content analysis.

In one example, metadata associated with one or more incidents (scenarios where undesirable content is detected in transactions) can be compared. The result of this comparison may be used to improve the ability of the models or system to flag or identify undesirable content. For example, illegal images may have similar metadata, or a large portion of the images may have similar metadata. This may allow a risk profile to be generated based on the extent to which the metadata matches or is sufficiently similar. This may allow offending clients to be identified, recipients to be identified, and may allow subsequent transactions to be rejected.

Models may be trained using a set of transactions that are normal. Thus, the model can determine whether a transaction or a set of transactions are normal. Transactions that are outliers may be identified as including undesirable content. Embodiments may operate to expand the abilities of content analysis systems or act in a standalone manner. Anecdotally, a group of reporters watching a secure building may note that food deliveries are increasing on a particular day. This metadata does not give information about what is happening inside the secure building, but allows deductions that something out of the ordinary is occurring. Similarly, content analysis functions configured to evaluate metadate, whether existing or derived, may allow transactions that contain undesirable content to be identified. These transactions can further be reported to an auditor for further action if necessary.

Even if some undesirable content is not identified, a node operator can still reduce their risk, show that genuine attempts are being made to reject undesirable content, and strive to comply with relevant requirements and regulations.

FIG. 2 discloses aspects of persisting a transaction to a distributed ledger. The method 200 may include receiving 202 a transaction from a client (e.g., a sender) at a node (or multiple nodes) of a distributed ledger. The node or nodes receiving the transaction may perform a protocol (e.g., a broadcast or gossip protocol) to spread 204 the transaction across all nodes of the distributed ledger.

In one example, each of the nodes may perform 206 validation operations. In some examples, specific nodes may be identified as consensus nodes may be tasked with determining whether to accept or reject a transaction in the distributed ledger. In this example, validation operations are performed 206 by all nodes in the distributed ledger and all nodes are considered to be consensus nodes.

In one example, the validation operations may include verifying the digital signatures of the client (e.g., the sender), ensuring that the transaction follows an acceptable format, and confirming that the sender has sufficient funds.

Performing 206 the validation operations may also include performing 216 content analysis operations. In one example, each node may access their own customized content analysis operations using APIs. Using APIs allows each node to perform their own content analysis (each node may use a different API or provide different arguments to an API). In one example, the content analysis accessed by a particular node is configured to identify undesirable content from that node’s perspective. Thus, the content analysis performed by one node may be different from the content analysis performed at other nodes. The content analysis operations performed by or for each node may include organization specific or node specific content analysis operations.

In one example, a nod operator may require transactions to include a certain value in a particular field, which may not be required by other organizations hosting a node of the distributed ledger. Thus, the content analysis operations performed by that node may include a check to determine whether that particular field contains a valid value or entry. This may result in a situation where one node votes against the transaction (reject) due to a node-specific compliance requirement while another node may vote to accept the transaction.

In another example, the content analysis operations are uniform across all nodes.

In another example, the content analysis operations 216 include metadata based content analysis operations. The metadata analysis operations are configured to evaluate metadata of the transaction (or of multiple transactions) to identify or determine whether a particular transaction or series of transactions includes undesirable subject matter. When undesirable content is identified or detected, reporting operations 218 are performed.

After the transaction is validated (or not validated) by the nodes (or the consensus nodes or sufficient portion thereof) and the content analysis determines that the transaction or its content is acceptable (or not acceptable), a consensus mechanism may be executed 208. Each node may vote according to the result of their validation and/or content analysis operations.

The consensus mechanism may take a variety of forms. In one example, each node casts a virtual vote on whether the transaction (or content) is acceptable or whether the transaction (or content) should be rejected. Thus, a node may vote accept or reject (e.g., via a Boolean response) in one example. The votes may be counted and where a sufficient number of accept votes are cast, consensus (Y at 210) is achieved.

In this example when consensus is achieved, The transaction may be simply committed 220 to the distributed ledger by each of the nodes.

In another example, each node may adjust 212 the transaction. More specifically, nodes that voted to accept the transaction may add a header to the transaction that includes the nodes that voted and their vote (e.g., accept or reject). Other information may be included (e.g., reasons of the nodes that rejected the transaction). Once the header is finalized, the transaction, with its header, is committed 220 to the distributed ledger by the nodes that voted to accept the transaction.

Nodes that voted to reject the transaction also adjust 212 their copy of the transaction by creating a header reflecting the votes as previously described. In addition, in one example, the transaction (or content or portion of the content) is hashed. Thus, the nodes that voted to reject the transaction store the header and a hash of the transaction when committing 216 the transaction to their copy of the distributed ledger. The header may not be hashed.

If the transaction does not received enough accept votes, the voting does not reach the required threshold (N at 210). Because consensus is not achieved by the consensus mechanism, the transaction is rejected 214 and not stored in the distributed ledger by any of the nodes.

FIG. 3 discloses additional aspects of detecting undesirable content and preventing undesirable content from being stored at the replica ledgers maintained by nodes participating in a distributed ledger. FIG. 3 further discloses aspects of storing transactions by nodes that voted to reject a transaction that has achieved consensus in the distributed ledger.

FIG. 3 illustrates a distributed ledger 300 that includes nodes 304, 306, 308, and 310, each having a replica of the distributed ledger. In this example, a client 302 submits 324 a transaction 326 to nodes 304 and 306. Thus, the transaction 326 is received at nodes 304 and 306 of the distributed ledger 300. The transaction is then spread by the receiving nodes to the other nodes in the distributed ledger 300. In this example, the node 304 spreads the transaction 326 to the node 308 and the node 306 spreads the transaction 326 to the node 310.

Next, the nodes 304, 306, 308, and 310 validate 314 the transaction. In one example, the validation 314 is substantially the same at each of the nodes 304, 306, 308, and 310. These validation operations may include verifying signatures, verifying a format of the transaction (or message), ensuring that the client 302 has a sufficient balance, or the like.

As illustrated in FIG. 3, the nodes 304, 306, 308, and 310 call 316 their respective content analysis functions (e.g., 318a-318d) using respective APIs. More specifically, in this example, the node 304 is associated with a content analysis 318a, the node 306 is associated with a content analysis 318b, the node 308 is associated with a content analysis 318c, and the node 310 is associated with a content analysis 318d. The content analysis 318a is specific to the requirements of the node 304. Similarly the content analysis 318b, 318c, and 318d are specific to the requirements of, respectively, the nodes 306, 308, and 310.

The content of the transaction 326 is analyzed by each of the nodes 304, 306, 308, and 310 using, respectively, the content analysis 318a, 318b, 318c, and 318d. The content analysis performed by the content analysis 318a-318d may be performed independently and separately. Further, the content analysis 318a may differ from the other content analysis 318b-318d.

In another example, the content analysis 318a-318d are identical, but are performed by the nodes independently.

Content analysis operations may include, but are not limited to, detecting malicious elements (e.g., malware), content anomalies, fraudulent behavior, keywords as defined by a provider of the distributed ledger, illegal images, or the like or combinations thereof. The content of the transaction 326 can be analyzed using various rules, machine learning (e.g., a model trained on valid and/or undesirable content), or the like.

The ability of the node 304 to call 316 a content analyzer 318a and submit the transaction 326 for content analysis adds a dynamic aspect to the content analysis and allows each node to perform its own content analysis independently of the other nodes in the distributed ledger. In addition, the consensus mechanism protocol is unaffected and can be deployed or upgraded on new or existing nodes of the distributed ledger 300, while providing organizations (or node operators) with the flexibility of applying their own specific content analysis. Each operator can generate their own content analysis functions and make them accessible via an API or in another manner.

In one example, the content analysis 318a-318d may include metadata content analysis, which may be the same for each of the nodes 304, 306, 308, and 310. In one example, metadata content analysis includes analyzing the transaction 326 (and/or other transactions near in time to the transaction 326) using a machine learning model that receives metadata (or transaction/content features) as input. For example, the metadata content analysis may have access to all transaction withing a recent time period, by the same sender or IP address, or the like. Features (e.g., metadata) may be derived from these transactions and input to a model, which may output a prediction (e.g., a probability) indicating that the transaction includes undesirable content. Example metadata or features may include sender, receiver, IP address of sender, field usage (including free text, optional, optional fields), ratio of used space to total space for transaction and/or each field, included encrypted or encoded data, number of transactions uploaded in a time window, or the like or combinations thereof.

In addition to transactions being uploaded, the content analysis 318a-318d, including the metadata content analysis, may operate on accesses to existing transactions stored in the distributed ledger. Thus, multiple accesses by multiple clients to the same transaction or set of transactions may indicate that the transaction or set of transactions includes undesirable content. A model may be trained, using historical access data (e.g., normal transaction accesses), to identify accesses that appear anomalous or are outliers.

The nodes 304, 306, 308, and 310 may or may not report 328 to an auditor 312. For example, the transaction 326 may be reported only when undesirable content is detected. The auditor 312 may be an external auditor, a regulatory body, a compliance team, and/or the like. The report may include an identity of the client 302, a reason for submitting the report or flagging the transaction 326, the undesirable content, or the like or combinations thereof.

Because the content analysis 318a, 318b, 318c, and 318d are different in some examples, undesirable content may be reported by only some of the nodes. Further, a response of the content analysis 318a-318d may be a Boolean value indicating whether the transaction should be accepted or rejected.

The auditor 312 may act 320 on the report. If the auditor 312 is sufficiently associated with the distributed ledger 300, the auditor 312 may, of its own accord, reject the transaction. Alternatively, the auditor 312 may notify a relevant authority. This may be performed automatically. For example, if the node 304 issues a report that the transaction 326 includes illegal content, the auditor 312 may act 320 only with respect to the jurisdiction or regulatory authority associated with the node 304 at least because the content was not reported as illegal by the other nodes in this example.

In another example, after reporting 328 the content (or not reporting the content 328), the consensus mechanism is executed. In this example, the consensus mechanism for the nodes 304, 306, 308, and 310 includes cast votes 322 (e.g., virtual votes). Each node may vote to accept the transaction or reject the transaction. Casting votes 322 determines whether the transaction 326 is saved 332 to the ledger (e.g., the node commits the transaction 326 to their respective replicas or copies of the distributed ledger).

In one example, consensus is achieved when accept or yes votes achieve a required voting threshold level (e.g., above 50%, above 66%), which voting threshold level may be determined by the distributed ledger.

In one example, the nodes 306, 308, and 310 vote to accept the transaction 326 and the node 304 votes to reject the transaction 304. Consensus is achieved in this example. However, the transaction is committed to the respective ledgers differently. The nodes 306, 308, and 310 add 330 the votes of all nodes to the transaction (e.g., as a header or metadata). The header may identify each voting node and their vote. Once the header is added to the transaction, the nodes 306, 308, and 310 save 332 the transaction to the ledger. Requests for the transaction 326 by the nodes 306, 308, and 310 can be serviced by those nodes.

The node 304, which voted to reject the transaction, similarly adds 330 a header or metadata reflecting the votes of all of the nodes. However, the node 304 may generate a hash of the transaction (e.g., a hash of the transaction, of undesirable content of the transaction, of the header and the transaction). The node 304 then saves 334 the hash of the transaction to its copy of the distributed ledger. In one example, the node 304 saves the header and the hash.

Requests for the transaction 326 received by the node 304 can be redirected to one of the nodes 306, 308, and 310 using the header or metadata associated with the transaction. More specifically, the header identify which of the nodes actually store the content of the transaction based on their vote. The request will be directed to a node that stored the actual content or transaction. This may relieve the node 304 (or its operator) consequences related to storing, for example, illegal content.

Advantageously, embodiments of the invention ensure that each nodes stores either the content itself or a hash of the content along with pointers to the content. Clients can access the content and establish data integrity using any of the nodes. Embodiments of the invention allow nodes to reject content that do not comply with their regulations and policies while ensuring that the distributed ledger operates smoothly in situations where the node-specific content analysis operations result in conflicting decisions.

When adding 330 the vote to the transaction 326, the consensus mechanism may ensure that the header storing the vote is immutable, verifiable, and correct. In one example, the content analysis 318a-318d ensures that each of the nodes 304, 306, 308, and 310 are involved in the process of deciding whether to accept the transaction 326 based on their own considerations and requirements. More specifically, each of the nodes 304, 306, 308, and 310 can determine independently of the other nodes whether the transaction 326 includes undesirable content.

FIG. 4 discloses aspects of metadata content analysis. A metadata content analysis operation 400 may be performed with respect to both an upload operation 422 and an access operation 424. The upload operation 422 relates to transactions being added to the distributed ledger and the access operation 424 relates to transactions in a distributed ledger being accessed.

In the upload operation 422, which may occur in the context of a transaction being submitted or requested/initiated by a client, the transaction 402 may be received. In one example, the features 404 (e.g., metadata) are determined for the transaction. The features 404 may also include features from transactions within a time period of the transaction 402 (e.g., 10 seconds, 1 minute, 5 minutes), by the same sender, from the same IP address, or the like. If the number of transactions identified for consideration is large, the transactions may be filtered by sender, IP address, or the like). The features 404 are input to a model 406 that is configured to generate an output 408. The output 408 may be a probability or indication that the transaction 402 includes undesirable data. If the output is above a threshold probability, the transaction 402 (and/or related transactions) may be flagged or reported to an auditor. This may result in actions with respect to the sender, the distributed ledger, or the like.

The access operation 424 may be performed at various times, in response to a new transaction, or in response to a transaction being accessed. In this example, a transaction 412 may be accessed. Features 414 (e.g., metadata) may be derived or obtained such as time of access, identity of client, and the like. Further, similar information may be obtained from other clients accessing the same transaction 412. Additional metadata may include the number of accesses within a predetermined period of time. These features 414 may be input to a model 416 that is trained with historical data related to normal accesses. If the input generates an output 418 representing an outlier access, the transaction 412 may include undesired content. This may be reported to an auditor.

Advantageously, embodiments of the invention ensure that undesirable content is rejected or identified even when the content is encrypted or encoded. Embodiments of the invention help prevent undesirable content from being stored in the distributed ledger, which removes the complicated process of removing undesirable content from an immutable distributed ledger.

Embodiments of the invention validate transactions in a manner that may include customized content analysis from the node’s perspectives and may include metadata content analysis. Analyzing the content and/or metadata of a transaction allows undesirable content, such as malicious content, unethical content, non-compliant data, and the like, which may be stored in or included in the transaction (e.g., in free-form text fields, headers, optional fields, unused portions of existing fields) to be identified and rejected. Further, embodiments of the invention involve all (or a threshold number) of nodes in the content analysis to protect against compromised nodes. Embodiments of the invention further ensure that malicious clients (senders) and/or their content are detected and reported.

Content determined to be undesirable is not written to the distributed ledger. Embodiments of the invention proactively and advantageously prevent undesirable content from being written to the distributed ledger. This is an improved outcome compared to removing undesirable content that has already been committed to the distributed ledger. Removing existing undesirable content is substantially more difficult (may require a hard fork) due to the immutable nature of the distributed ledger. Embodiments also allow undesirable content already in the distributed ledger to be identified and/or reported based on content metadata analysis of the accesses to the transaction.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, distributed ledger operations, validation operations, content analysis operations, auditing operations, reporting operations, hashing operations, content replacement operations for nodes that object to the content/transaction, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data protection functionality for one or more clients. Another example of a cloud computing environment is one in which processing, data storage, data protection, and other services may be performed on behalf of one or more clients. More generally however, the scope of this disclosure is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment. Where VMs are employed, a hypervisor or other virtual machine monitor (VMM) may be employed to create and control the VMs. The term VM embraces, but is not limited to, any virtualization, emulation, or other representation, of one or more computing system elements, such as computing system hardware. A VM may be based on one or more computer architectures, and provides the functionality of a physical computer. A VM implementation may comprise, or at least involve the use of, hardware and/or software.

Example embodiments are applicable to any system capable of storing and handling various types of objects or data, in analog, digital, or other form.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method comprising: validating, by nodes of a distributed ledger, a transaction received into the distributed ledger, performing, by each of the nodes: performing a metadata content analysis on the transaction on the transaction, determining whether the transaction includes undesirable content based on an output of the metadata content analysis, and casting a vote based on a result of the metadata content analysis to accept the transaction into the distributed ledger or a vote to reject the transaction from being stored in the distributed ledger, and committing the transaction to the distributed ledger, by the nodes, when votes from the nodes to accept the transaction exceed a threshold voting requirement.

Embodiment 2. The method of embodiment 1, further comprising: receiving the transaction at one or more of the nodes in the distributed ledger, wherein the transaction is received from a client, and spreading the transaction to all of the nodes in the distributed ledger.

Embodiment 3. The method of embodiment 1 and/or 2, wherein the undesirable content includes malicious content, anomalous content, content related to or indicative of fraudulent behavior, keywords defined by a provider of the distributed ledger, malware, and/or illegal content including illegal images, wherein the undesirable content is encoded or encrypted.

Embodiment 4. The method of embodiment 1, 2, and/or 3, wherein the metadata content analysis extracts metadata from the transaction and/or from transactions within a specified time period of the transaction, the metadata including bits used in fields, whether any fields include extra data or unexpected values, a length of the transaction, lengths of specific fields in the transaction, ratios of used space to available space for the transactions and the fields, timing of the transaction and/or the transactions, sender of the transaction and/or the transactions, IP addresses of the senders, or combinations thereof.

Embodiment 5. The method of embodiment 1, 2, 3, and/or 4, further comprising inputting the metadata into a model trained to determine whether the transaction is an outlier with respect to normal transactions, wherein outlier transactions are identified as including the undesired content.

Embodiment 6. The method of embodiment 1, 2, 3, 4, and/or 5, wherein the transaction is being uploaded to the distributed ledger.

Embodiment 7. The method of embodiment 1, 2, 3, 4, 5, and/or 6, wherein the transaction is being accessed by a client, further comprising identifying other accesses to the transaction within a window and extracting metadata from the accesses.

Embodiment 8. The method of embodiment 1, 2, 3, 4, 5, 6, and/or 7, further comprising inputting the metadata into a model configured to determine whether the access is an outlier access, wherein the transaction is determined to include undesired content when the access is an outlier access.

Embodiment 9. The method of embodiment 1, 2, 3, 4, 5, 6, 7, and/or 8, wherein the content analysis performed by a particular node is based on content and/or compliance requirements of that particular node or is the same as other nodes, further comprising reporting the transaction to an auditor by the nodes that determine that the transaction includes the undesirable content, wherein the auditor is an external auditor, a regulatory body, or a compliance entity and is configured to act with respect to the nodes that reported the transaction.

Embodiment 10. The method of embodiment 1, 2, 3, 4, 5, 6, 7, 8, and/or 9, further comprising adding a header to the transaction by each of the nodes, wherein the nodes that voted to reject the transaction each generate their own hash of the transaction, wherein the header includes a voting history of each of the nodes for the transaction, the voting history including identities of nodes in the distributed ledger and their votes.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments or edge environment where one or more of a client, server, or other machine may reside and operate in a cloud environment or edge environment.

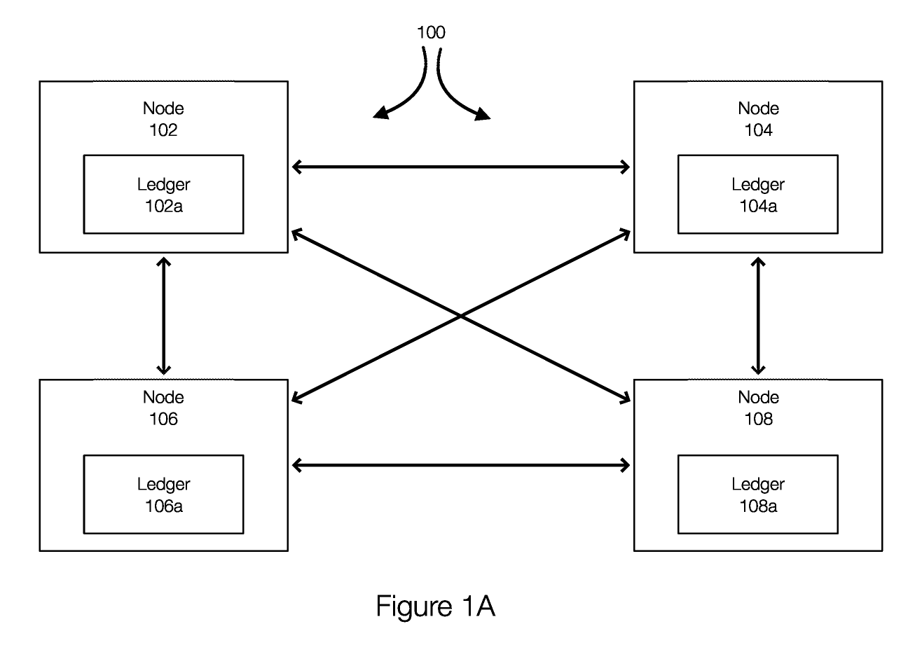

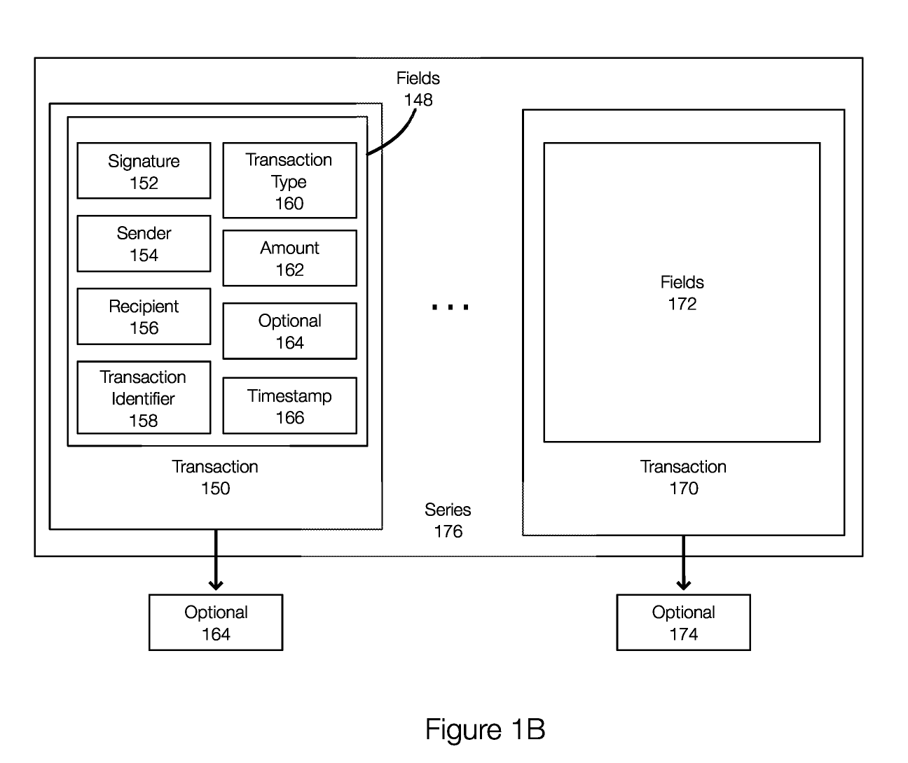

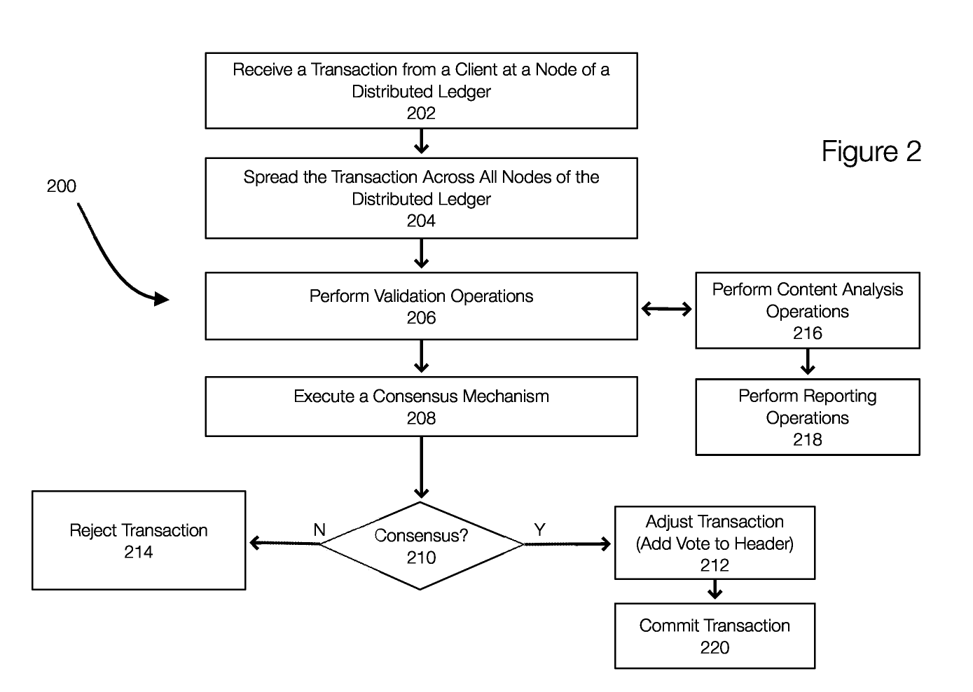

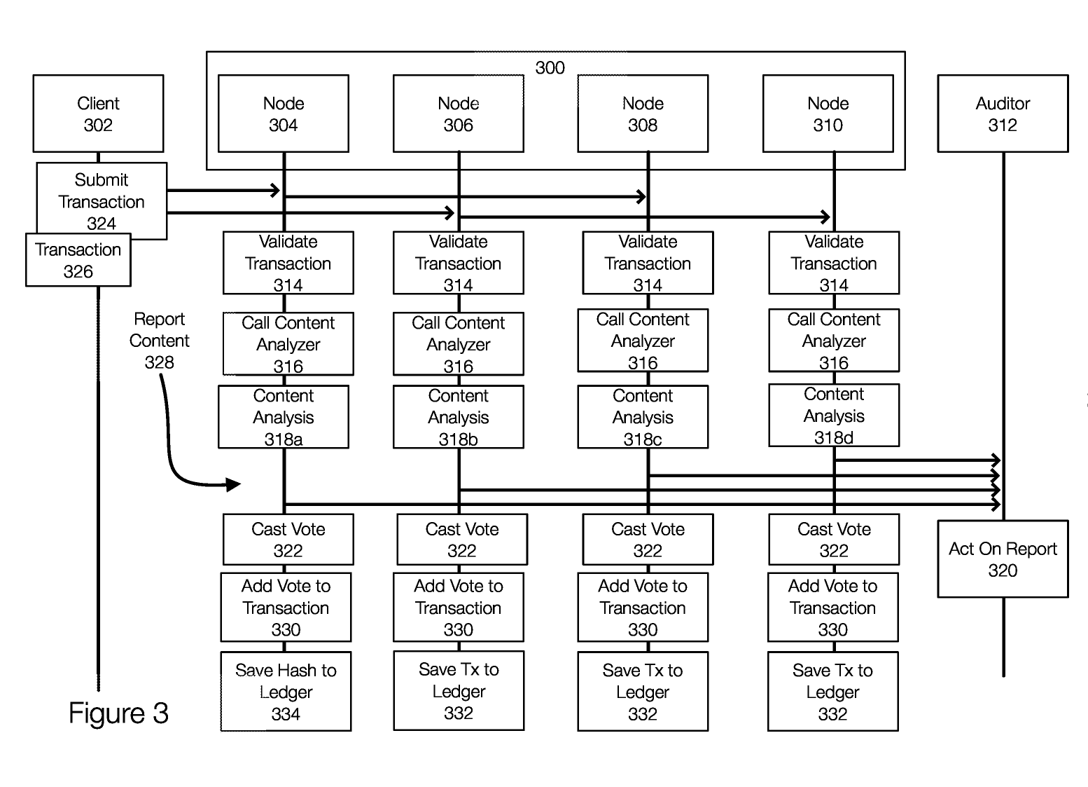

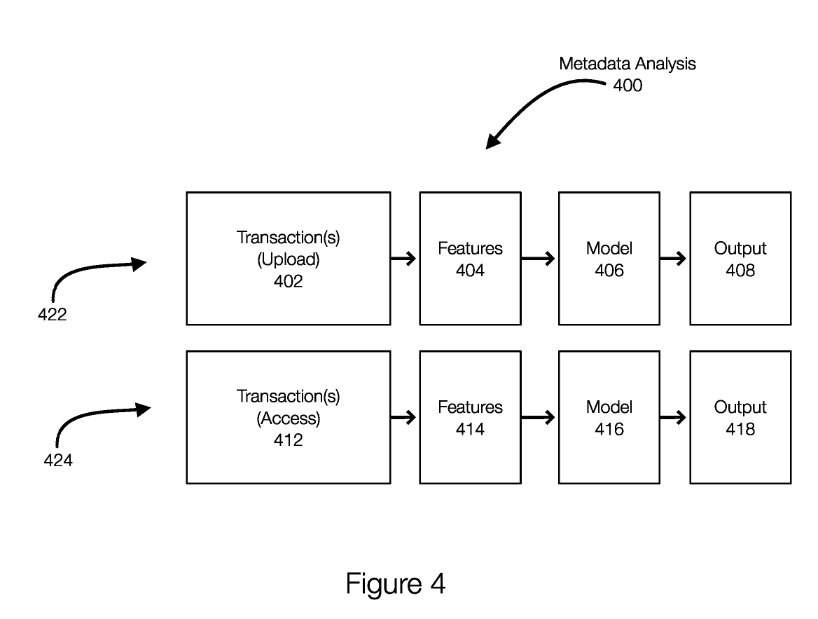

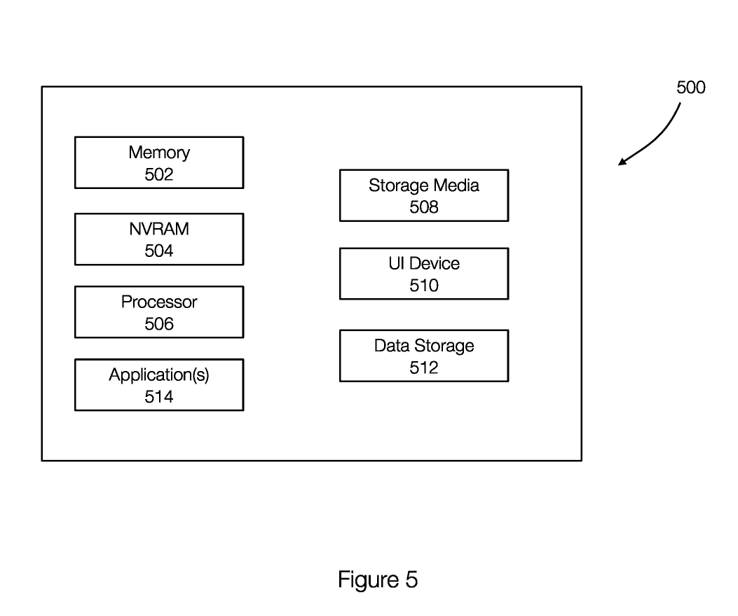

With reference briefly now to FIG. 5, any one or more of the entities disclosed, or implied, by Figures, and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method comprising:
validating, by nodes of a distributed ledger, a transaction received into the distributed ledger;
performing, by each of the nodes:
performing a metadata content analysis on the transaction on the transaction;
determining whether the transaction includes undesirable content based on an output of the metadata content analysis; and
casting a vote based on a result of the metadata content analysis to accept the transaction into the distributed ledger or a vote to reject the transaction from being stored in the distributed ledger; and
committing the transaction to the distributed ledger, by the nodes, when votes from the nodes to accept the transaction exceed a threshold voting requirement.

2. The method of claim 1, further comprising:
receiving the transaction at one or more of the nodes in the distributed ledger, wherein the transaction is received from a client; and
spreading the transaction to all of the nodes in the distributed ledger.

3. The method of claim 1, wherein the undesirable content includes malicious content, anomalous content, content related to or indicative of fraudulent behavior, keywords defined by a provider of the distributed ledger, malware, and/or illegal content including illegal images, wherein the undesirable content is encoded or encrypted.

4. The method of claim 3, wherein the metadata content analysis extracts metadata from the transaction and/or from transactions within a specified time period of the transaction, the metadata including bits used in fields, whether any fields include extra data or unexpected values, a length of the transaction, lengths of specific fields in the transaction, ratios of used space to available space for the transactions and the fields, timing of the transaction and/or the transactions, sender of the transaction and/or the transactions, IP addresses of the senders, or combinations thereof.

5. The method of claim 4, further comprising inputting the metadata into a model trained to determine whether the transaction is an outlier with respect to normal transactions, wherein outlier transactions are identified as including the undesired content.

6. The method of claim 1, wherein the transaction is being uploaded to the distributed ledger.

7. The method of claim 1, wherein the transaction is being accessed by a client, further comprising identifying other accesses to the transaction within a window and extracting metadata from the accesses.

8. The method of claim 7, further comprising inputting the metadata into a model configured to determine whether the access is an outlier access, wherein the transaction is determined to include undesired content when the access is an outlier access.

9. The method of claim 1, wherein the content analysis performed by a particular node is based on content and/or compliance requirements of that particular node or is the same as other nodes, further comprising reporting the transaction to an auditor by the nodes that determine that the transaction includes the undesirable content, wherein the auditor is an external auditor, a regulatory body, or a compliance entity and is configured to act with respect to the nodes that reported the transaction.

10. The method of claim 1, further comprising adding a header to the transaction by each of the nodes, wherein the nodes that voted to reject the transaction each generate their own hash of the transaction, wherein the header includes a voting history of each of the nodes for the transaction, the voting history including identities of nodes in the distributed ledger and their votes.

11. A non-transitory storage medium having stored therein instructions that are executable by one or more hardware processors to perform operations comprising:
validating, validating, by nodes of a distributed ledger, a transaction received into the distributed ledger;
performing, by each of the nodes:
performing a metadata content analysis on the transaction on the transaction;
determining whether the transaction includes undesirable content based on an output of the metadata content analysis; and
casting a vote based on a result of the metadata content analysis to accept the transaction into the distributed ledger or a vote to reject the transaction from being stored in the distributed ledger; and
committing the transaction to the distributed ledger, by the nodes, when votes from the nodes to accept the transaction exceed a threshold voting requirement.

12. The non-transitory storage medium of claim 11, further comprising:
receiving the transaction at one or more of the nodes in the distributed ledger, wherein the transaction is received from a client; and
spreading the transaction to all of the nodes in the distributed ledger.

13. The non-transitory storage medium of claim 11, wherein the undesirable content includes malicious content, anomalous content, content related to or indicative of fraudulent behavior, keywords defined by a provider of the distributed ledger, malware, and/or illegal content including illegal images, wherein the undesirable content is encoded or encrypted.

14. The non-transitory storage medium of claim 13, wherein the metadata content analysis extracts metadata from the transaction and/or from transactions within a specified time period of the transaction, the metadata including bits used in fields, whether any fields include extra data or unexpected values, a length of the transaction, lengths of specific fields in the transaction, ratios of used space to available space for the transactions and the fields, timing of the transaction and/or the transactions, sender of the transaction and/or the transactions, IP addresses of the senders, or combinations thereof.

15. The non-transitory storage medium of claim 14, further comprising inputting the metadata into a model trained to determine whether the transaction is an outlier with respect to normal transactions, wherein outlier transactions are identified as including the undesired content.

16. The non-transitory storage medium of claim 11, wherein the transaction is being uploaded to the distributed ledger.

17. The non-transitory storage medium of claim 11, wherein the transaction is being accessed by a client, further comprising identifying other accesses to the transaction within a window and extracting metadata from the accesses.

18. The non-transitory storage medium of claim 17, further comprising inputting the metadata into a model configured to determine whether the access is an outlier access, wherein the transaction is determined to include undesired content when the access is an outlier access.

19. The non-transitory storage medium of claim 11, wherein the content analysis performed by a particular node is based on content and/or compliance requirements of that particular node or is the same as other nodes, further comprising reporting the transaction to an auditor by the nodes that determine that the transaction includes the undesirable content, wherein the auditor is an external auditor, a regulatory body, or a compliance entity and is configured to act with respect to the nodes that reported the transaction.

20. The non-transitory storage medium of claim 11, further comprising adding a header to the transaction by each of the nodes, wherein the nodes that voted to reject the transaction each generate their own hash of the transaction, wherein the header includes a voting history of each of the nodes for the transaction, the voting history including identities of nodes in the distributed ledger and their votes.
